(19) United States
(12) Patent Application Publication
(10) Pub. No.: US 2006/0061696 A1
(43) Pub. Date: Mar. 23, 2006

(54) Signal reproduction apparatus and signal reproduction method

(75) Inventor: Akira Miyazawa, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Minato-ku (JP)

(21) Appl. No.: 11/214,939

(22) Filed: Aug. 31, 2005

(30) Foreign Application Priority Data
Sep. 7, 2004 (JP) 2004-260059

(51) Int. Cl. H04N 5/66; H04N 9/12

(52) U.S. Cl. 348/739

(57) ABSTRACT

A signal reproduction apparatus includes a first operation handler configured to enable respective signals input to a plurality of input terminals to be cyclically selectable in a predetermined sequence, a second operation handler configured to enable respective signals input to the plurality of input terminals to be cyclically selectable in a sequence opposite the predetermined sequence associated with the first operation handler, and a signal processing means configured to perform a reproduction process on a signal selected by using at least one of the first and second operation handlers.

### CROSS-REFERENCE TO RELATED APPLICATIONS

This application is based upon and claims the benefit of priority from prior Japanese Patent Application No. 2004-260059, filed Sep. 7, 2004, the entire contents of which are incorporated herein by reference.

### BACKGROUND OF THE INVENTION

1. Field of the Invention

The present invention relates to a signal reproduction apparatus and a signal reproduction method for reproducing a video signal and an audio signal etc. from an input signal.

2. Description of the Related Art

As is well known, in recent years, digitization of television broadcasts has been advanced and promoted. For example, in Japan, not only satellite digital broadcasting, such as broadcasting satellite (BS) digital broadcasting and 110° communication satellite (CS) digital broadcasting, terrestrial digital broadcasting has started their services.

Large-scale digital (television) broadcast receivers for receiving digital television broadcasts operates with a connected mass-storage digital recording device such as a hard disk drive (HDD), thereby to enable processing, such as digital recording of received broadcast programs and reproduction of recorded broadcast programs.

In addition, such a digital television broadcast receiver of the above-described type has a plurality of external input terminals which input an analog input signal including a video signal and an audio signal from an external source. Thereby, the video and audio signals etc. are reproduced from the analog input signal supplied to an external input terminal selected by a user, and corresponding video and audio can be listened and viewed.

More specifically, in the receiver, an input switch key of a remote controller is operated by the user to select a desired external input terminal, thereby to enable input switching. In this case, importance is focused on the provision of input switch operation means capable of quickly selecting a desired terminal from among the plurality of external input terminals even with input switch keys not increased in number.

Jpn. Pat. Appln. KOKAI Publication No. 2002-118794 discloses a receiver which allows channel-button up/down operations of a remote controller, thereby enabling successive selection of channels of an external tuner and an internal tuner.

In addition, Jpn. Pat. Appln. KOKAI Publication No. 2003-153098 discloses a television receiver which contains information necessary for channel switching of external devices, whereby broadcasts of the external devices can be viewed and listened through regular channel switching operation.

Further, Jpn. Pat. Appln. KOKAI Publication No. 2002-252887 discloses a technique for enabling customization setting of a remote control transmitter through simple operation.

### BRIEF SUMMARY OF THE INVENTION

According to one aspect of the present invention, there is provided a signal reproduction apparatus comprising: a plurality of input terminals; a first operation handler configured to enable respective signals input to the plurality of input terminals to be cyclically selectable in a predetermined sequence; a second operation handler configured to enable respective signals input to the plurality of input terminals to be cyclically selectable in a sequence opposite the predetermined sequence associated with the first operation handler; and a signal processing means configured to perform a reproduction process on a signal selected by using at least one of the first and second operation handlers.

According to another aspect of the present invention, there is provided a signal reproduction method which selects a predetermined signal from respective signals input to a plurality of input terminals and which performs a reproduction process on the selected signal, the method comprising: a first step of determining which of a first operation handler and a second operation handler has been operated; a second step of, when it is determined that the first operation handler has been operated, performing cyclic selection of the respective signals input to the plurality of input terminals in a predetermined sequence; a third step of, when it is determined that the second operation handler has been operated, performing cyclic selection of the respective signals input to the plurality of input terminals in a sequence opposite the predetermined sequence associated with the first operation handler; and a fourth step of performing the reproduction process on a signal selected in the second or third step.

### BRIEF DESCRIPTION OF THE SEVERAL VIEWS OF THE DRAWING

FIG. 1 is a schematic diagram descriptive of an embodiment of the present invention, showing examples of a digital television broadcast receiver and a network system configured with the broadcast receiver in the center;

FIG. 2 is a block diagram descriptive of a major signal processing system of the digital television broadcast receiver according to the embodiment;

FIG. 3 is an exterior view descriptive of a remote controller of the digital television broadcast receiver according to the embodiment;

FIG. 4 is a view descriptive of an example of an input switch display area being displayed in an input switch event of the digital television broadcast receiver according to the embodiment;

FIG. 5 is a flow chart descriptive of an input switch operation of the digital television broadcast receiver according to the embodiment; and

FIG. 6 is a view descriptive of another example of the input switch display area being displayed in the input switch event of the digital television broadcast receiver according to the embodiment.

### DETAILED DESCRIPTION OF THE INVENTION

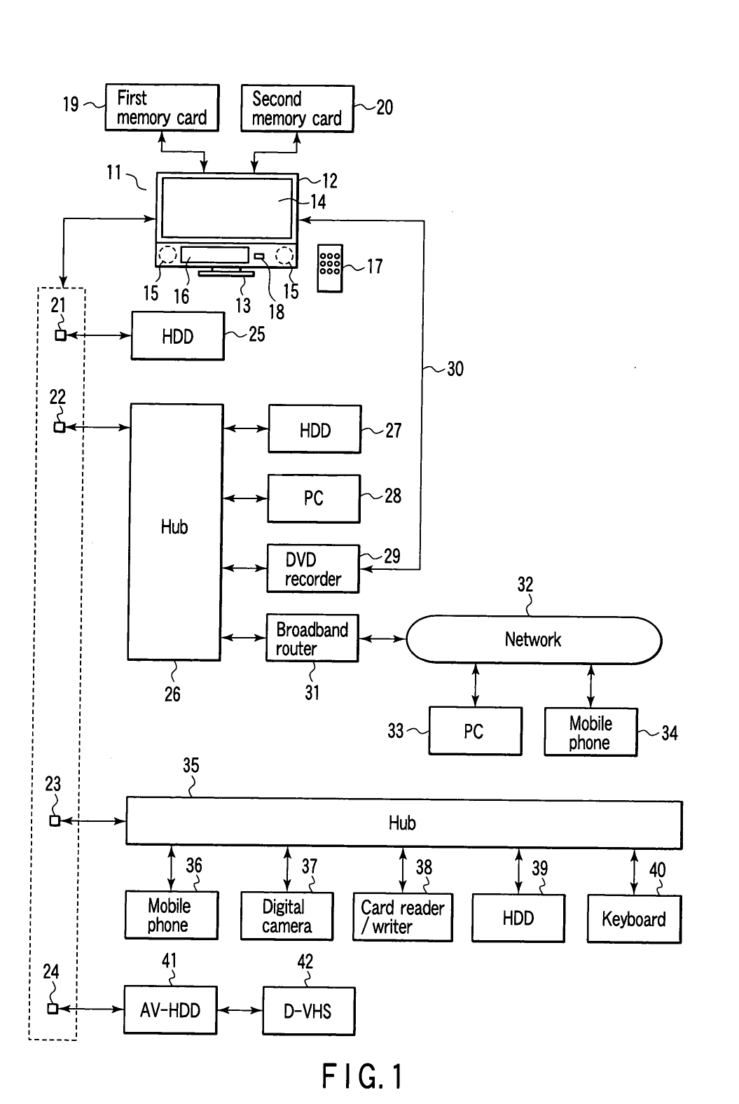

An embodiment of the present invention will be described in detail hereafter with reference to the drawings. FIG. 1 is a schematic diagram showing examples of the exterior of a digital television broadcast receiver 11, which will be described in the embodiment, and of a network system configured with the digital television broadcast receiver 11 deployed in the center.

The digital television broadcast receiver 11 is configured mainly of a thin cabinet 12 and a support 13 which supports the cabinet 12 in elevation. The cabinet 12 includes, but not limited to, a flat-panel video display 14 formed of a liquid crystal display panel or the like, a loudspeaker 15, an operation section 16, and a photo-receiver section 18 which receives operation information sent from a remote controller 17.

The digital television broadcast receiver 11 allows a first memory card 19, such as a secure digital (SD) memory card, a multimedia card (MMC), or a memory stick, to be attachable and detachable. Recording and/or reproduction of information, such as broadcast programs and photographs, are performed using the first card 19.

The digital television broadcast receiver 11 further allows a second memory card (IC card) 20 in which contract or agreement information and the like are recorded, to be attachable and detachable. Recording and/or reproduction of information, such as broadcast programs and photographs, are performed using the first card 19.

The digital television broadcast receiver 11 further includes a first local area network (LAN) terminal 21, a second LAN terminal 22, a universal serial bus (USB) terminal 23, and an i.Link terminal 24.

Among these terminals, the first LAN terminal 21 is used as a LAN-supported HDD dedicated port. Over a LAN-supported HDD 25 being used as a connected network attached storage (NAS), information recording and/or reproduction is performed through Ethernet (registered trademark).

Thus, since the first LAN terminal 21, serving as the LAN-supported HDD dedicated port, is provided, information recording of broadcast programs in accordance with “hi-vision” image quality can be stably performed into the HDD 25 without being influenced by, for example, an other network environment and/or network use condition.

The second LAN terminal 22 is used as a general-purpose LAN-supported port using Ethernet (registered trademark). For example, the second LAN terminal 22 is used for communication of information with devices connected through a hub 26. The devices are, for example, a LAN-supported HDD 27, a personal computer (PC) 28, and an HDD-included digital versatile disk (DVD) recorder 29.

Digital information being communicated with the DVD recorder 29 through the second LAN terminal 22 is limited only to information related to control systems. Therefore, a dedicated analog communication line 30 should be provided to the DVD recorder 29 for communication of analog video and audio information with the digital television broadcast receiver 11.

In addition, the second LAN terminal 22 is used for connection to a network 32, such as the Internet, through a broadband router 31 connected to the hub 26, thereby to allow information communication with devices, such as a PC 33 and a mobile phone 34.

The USB terminal 23 is used as a general-purpose USB-supported port. For example, the USB terminal 23 is used for connection to USB devices, such as a mobile phone 36, a digital camera 37, a card reader/writer 38 corresponding to the memory cards, an HDD 39, and a keyboard 40 which are connected to through a hub 35, thereby to allow information communication with the USB devices.

The i.Link terminal 24 is used for serial connection to devices, such as an AV-HDD 41 and a digital-video home system (D-VHS) 42, thereby to allow information communication with the devices.

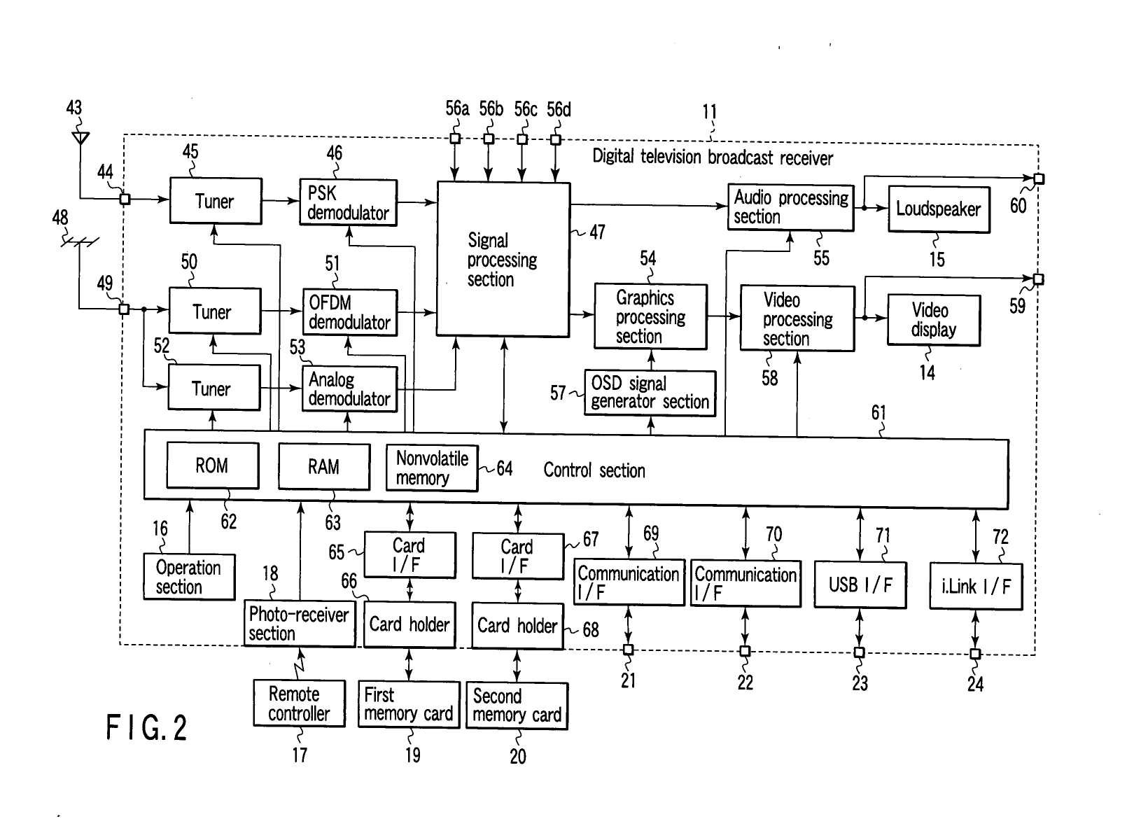

FIG. 2 shows a major signal processing system of the digital television broadcast receiver 11. A satellite digital television broadcast signal received through an antenna 43 responsible for receiving BS/CS digital broadcasts is supplied through an input terminal 44 to a tuner 45 corresponding to satellite digital broadcasts, thereby to select a broadcast signal on a desired channel.

A broadcast signal selected by the tuner 45 is supplied to a phase shift keying (PSK) demodulator 46 and is demodulated thereby to a digital video signal and a digital audio signal. The digital video and audio signals are then output to a signal processing section 47.

A terrestrial digital television broadcast signal received through an antenna 48 responsible for receiving terrestrial wave broadcasts is supplied through an input terminal 49 to a tuner 50 corresponding to terrestrial digital broadcasts, thereby to select a broadcast signal on a desired channel.

The broadcast signal selected by the tuner 50 is supplied to an orthogonal frequency division multiplexing (OFDM) demodulator 51 and is demodulated to digital video and audio signals. Thereafter, the digital video and audio signals are output to the signal processing section 47.

A terrestrial analog television broadcast signal received through the antenna 48 responsible for receiving terrestrial wave broadcasts is supplied through the input terminal 49 to a tuner 52 corresponding to terrestrial analog broadcasts, thereby to select a broadcast signal on a desired channel. The broadcast signal selected by the tuner 52 is supplied to an analog demodulator 53 and is demodulated to an analog video signal and an analog audio signal. Thereafter, the analog video and audio signals are output to the signal processing section 47.

The signal processing section 47 selectively applies predetermined digital signal processing on the digital video and audio signals respectively supplied from the PSK demodulator 46 and the OFDM demodulator 51, and then supplies the signals to a graphics processing section 54 and an audio processing section 55.

A plurality of (four in the drawing) external input terminals 56a, 56b, 56c, and 56d are connected to the signal processing section 47. Of these input terminals, the external input terminals 56a to 56c individually enable analog video and audio signals to be input externally of the digital television broadcast receiver 11.

The external input terminal 56d is a high definition multimedia interface (HDMI) terminal, and enables digital video and audio signals to be input externally of the digital television broadcast receiver 11.

The signal processing section 47 selectively digitizes the analog video and audio signals respectively supplied from the analog demodulator 53 and the external input terminals 56a to 56c, applies predetermined digital signal processing on the digitized video and audio signals, and then outputs the signals to the graphics processing section 54 and the audio processing section 55.

In addition, the signal processing section 47 applies predetermined digital signal processing on the digital video and audio signals supplied from the external input terminal 56d, and then outputs the signals to the graphics processing section 54 and the audio processing section 55.

The graphics processing section 54 has a function of producing an output by superimposing an on-screen display (OSD) signal generated by an OSD signal generator section 57 on the digital video signal supplied from the signal processing section 47. The graphics processing section 54 is capable of selectively outputting an output video signal of the signal processing section 47 and an output OSD signal of the OSD signal generator section 57. In addition, the graphics processing section 54 is capable of producing the outputs from the two sections in combination such that each of the signals configures the half of a screen.

The digital video signal having been output from the graphics processing section 54 is then supplied to an image output section 58. The image output section 58 transforms the input digital video signal into an analog video signal having a format displayable on the video display 14, then outputs the signal to the video display 14, and then causes the signal to be derived to the outside through an output terminal 59.

The audio processing section 55 transforms the input digital audio signal into an analog audio signal having a format reproducible by the loudspeaker 15, then outputs the signal to the loudspeaker 15, and then causes the signal to be derived to the outside through an output terminal 60.

The digital television broadcast receiver 11 is totally controlled by a control section 61 for the overall operation including the various receiving operations described above. The control section 61 contains a built-in central processing unit (CPU) and others. The control section 61 receives operation information from the operation section 16, or alternatively receives through the light receiver section 18 operation information sent from the remote controller 17, thereby to control individual sections such that content of the operation is reflected.

In the above case, the control section 61, mainly, uses a read only memory (ROM) 62 having stored therein control programs executed by the CPU, a random access memory (RAM) 63 for providing the CPU with work areas, and a nonvolatile memory 64 in which, for example, various setting information and control information are stored.

The control section 61 is connected through a card interface (I/F) 65 to a card holder 66 into which the first memory card 19 is attachable. Thereby, the control section 61 is capable of performing information communication through the card I/F 65 with the first memory card 19 attached to the card holder 66.

The control section 61 is connected through a card I/F 67 to a card holder 68 into which the second memory card 20 is attachable. Thereby, the control section 61 is capable of performing information communication through the card I/F 67 with the second memory card 20 attached to the card holder 68.

The control section 61 is further connected through a card I/F 69 to the first LAN terminal 21. Thereby, the control section 61 becomes able to perform information communication through the card I/F 69 with the LAN-supported HDD 25 connected to the first LAN terminal 21. The control section 61 has a dynamic host configuration protocol (DHCP) server function, thereby to perform the control by allocating Internet protocol (IP) addresses to the LAN-supported HDD 25 connected to the first LAN terminal 21.

The control section 61 is further connected through a communication I/F 70 to the second LAN terminal 22. Thereby, the control section 61 becomes able to perform information communication through the communication I/F 70 with the respective devices connected to the second LAN terminal 22 (see FIG. 1).

The control section 61 is further connected through a USB I/F 71 to the USB terminal 23. Thereby, the control section 61 becomes able to perform information communication through the USB I/F 71 with the respective devices connected to the USB terminal 23 (see FIG. 1).

The control section 61 is further connected through an i.Link 72 to the i.Link terminal 24. Thereby, the control section 61 becomes able to perform information communication through the i.Link 72 with the respective devices connected to the i.Link terminal 24 (see FIG. 1).

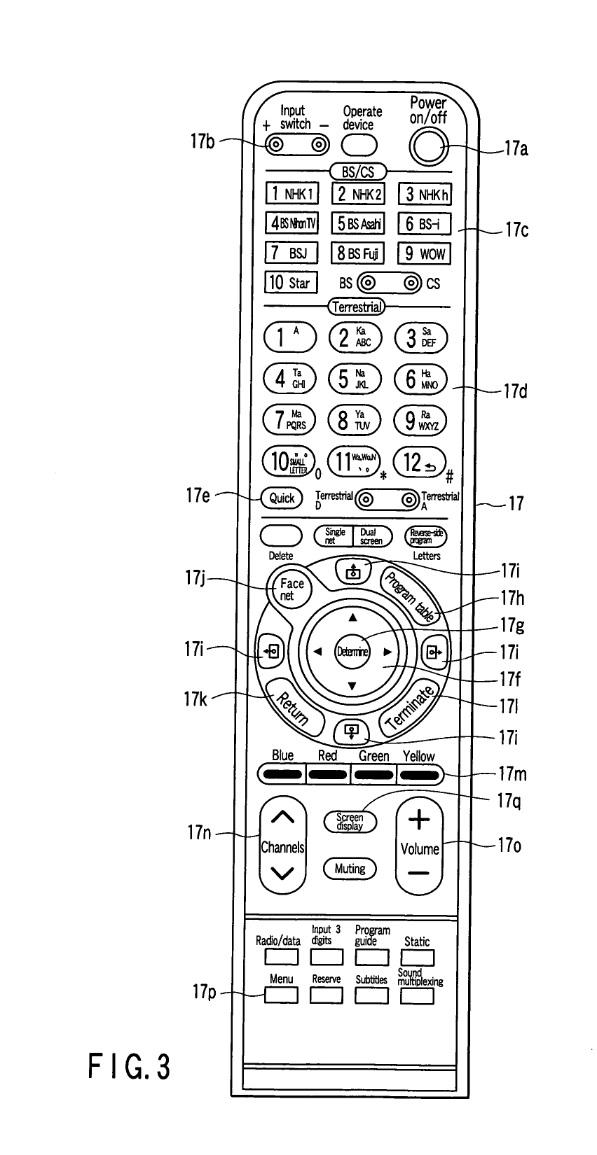

FIG. 3 shows the exterior of the remote controller 17. The remote controller 17, mainly, includes keys such as a power on/off key 17a, an input switch key 17b, a direct selection key 17c for a satellite broadcast channel, a direct selection key 17d for a terrestrial wave channel, a quick key 17e, a cursor key 17f, a determination key 17g, a program table key 17h, a page switch key 17i, a face net (navigation) key 17j, a return key 17k, an end key 17l, color keys 17m for blue, red, green, and yellow colors, a channel-change up/down key 17n, a volume tune key 17o, a menu key 17p, and a screen display key 17q.

The input switch key 17b of the remote controller 17 is used to selectively switch among respective signals which are input and broadcast signals received through the four external input terminals 56a to 56d.

That is, the input switch key 17b is supported such that two ends thereof are selectively depressible as seesaw movement with a central portion thereof in the center. In the input switch key 17b, the one depressible end corresponds to input switching in a “+” side, that is, forward direction, and the other depressible end corresponds to input switching in a “−” side, that is, backward direction.

More specifically, every time a “+” side of the input switch key 17b is operated, the input is cyclically switched in the order (forward direction) as: external input terminal 56a→external input terminal 56b→external input terminal 56c→external input terminal 56d→Broadcast→external input terminal 56a.

On the other hand, every time a “−” side of the input switch key 17b is operated, the input is cyclically switched in a broadcast order (direction opposite the forward direction) as: Broadcast→external input terminal 56d→external input terminal 56c→external input terminal 56b→external input terminal 56a→Broadcast.

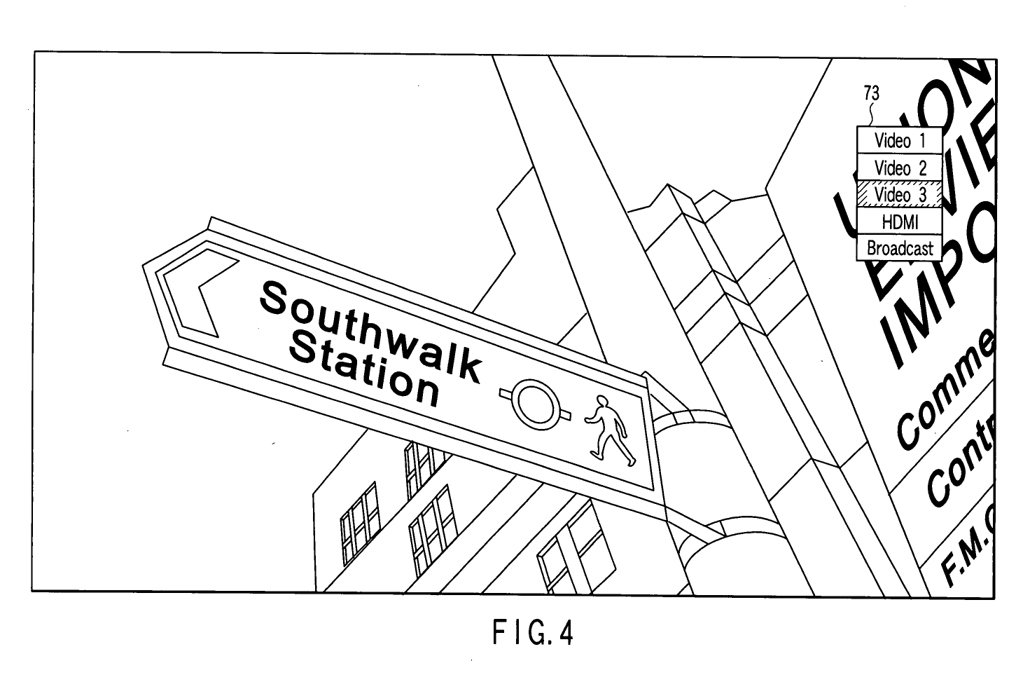

As shown in FIG. 4, an input switching condition is indicated by an input switch display area 73 that is displayed in the OSD form on the screen of the video display 14. The input switch display area 73 is displayed on the screen only for a preset predetermined time on the condition that, for example, the input switch key 17b, screen display key 17q or the like has been operated.

The input switch display area 73 shown in FIG. 4 list-displays the items of “Video 1” corresponding to the external input terminal 56a, “Video 2” corresponding to the external input terminal 56b, “Video 3” corresponding to the external input terminal 56c, “HDMI” corresponding to the external input terminal 56d, and “Broadcast” corresponding to broadcasting.

In the input switch display area 73, an item corresponding to a selected input is displayed in a color different from colors for other items. In FIG. 4, “Video 3”, i.e., the state where the external input terminal 56c is selected, is shown as a hatched portion by way of example.

Accordingly, in the input switch display area 73, every time the “+” side of the input switch key 17b is operated, the selected item is cyclically switched in the order (forward direction) in the order as: Video 1→Video 2→Video 3→HDMI→Broadcast→Video 1.

Alternatively, in the input switch display area 73, every time the “−” side of the input switch key 17b is operated, the selected item is cyclically switched in the order (direction opposite the forward direction) in the order as: Broadcast→HDMI→Video 3→Video 2→Video 1→Broadcast.

Thus, the input switch key 17b is selectively operable to the “+” or “−” side, and the input is cyclically switchable between the forward and backward (opposite) directions and the reverse direction. Accordingly, a plurality of external inputs can be quickly selected through the simple operation even with keys not increased in number.

In this regard, according to prior arts, the input cannot be cyclically switched in more than one direction, so that users are inconvenienced by poor operability in selection of a desired input. However, according to the present embodiment, since the input can be cyclically switched in two directions, a desired input can be efficiently selected.

Every time the input switch key 17b is operated to one of the “+” and “−” sides for input switching, reproduction processes are executed on video and audio corresponding to an input selected through the switch operation. That is, switching occurs between video and audio in synchronism with the operation of the input switch key 17b.

A preliminary-input scheme may be employed for the operation of the input switch key 17b. For example, a case is assumed where the external input terminal 56a is selected, video and audio signals reproduced from a signal input through the external input terminal 56a are viewed and listened, and one of the “+” and “−” sides of the input switch key 17b is intermittently operated at a time interval less than a preset predetermined time. In this case, a video image corresponding to the input signal from the external input terminal 56a remains displayed on the screen, but sequential switching takes place among only the items of the input switch display area 73 being displayed to be superimposed on the video image.

When the operation of the input switch key 17b is paused for a predetermined time in the state where a desired input is selected by a user, reproduction processes are executed on video and audio signals of the selected input, thereby being submitted for viewing and listening. Thus, with the preliminary-input scheme being employed, the user does not have to view video images in the course of input switching.

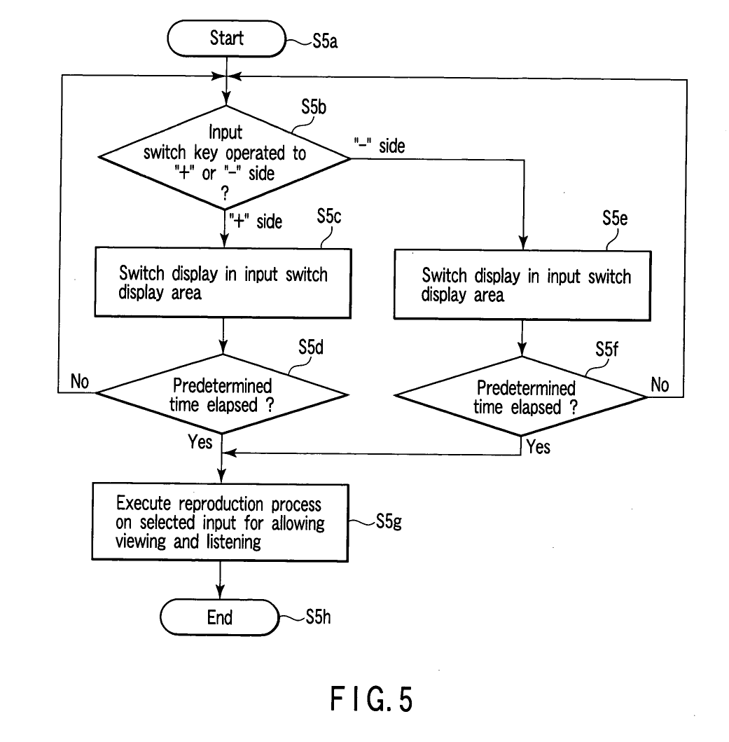

FIG. 5 is a flow chart collectively showing the series of operations described above in the event that the input switch key 17b is selectively operated to the “+” and “−” sides. Upon start of processing (step S5a), the control section 61 in step S5b determines which of the “+” and “−” sides of the input switch key 17b is operated.

If it is determined that the “+” side of the input switch key 17b is operated (“+” side), the control section 61 switches the item selection display on the input switch display area 73 in step S5c. Thereafter, in step S5d, the control section 61 determines whether or not a preset predetermined time has elapsed. If it is determined that the time has not elapsed (“NO”), control returns to processing in step S5b.

If it is determined that the “−” side of the input switch key 17b is operated in step S5b (“−” side), the control section 61 switches the item selection display on the input switch display area 73 in step S5e. Thereafter, in step S5f, the control section 61 determines whether or not the preset predetermined time has elapsed. If it is determined that the time has not elapsed (“NO”), control returns to processing in step S5b.

If it is determined that the preset predetermined time has elapsed in step S5d or S5f (“YES”), the control section 61 in step S5g executes the reproduction processes on video and audio signals of an input corresponding to a currently selected item in the input switch display area 73 and causes the signals to be submitted for viewing and listening, and thereafter terminates processing (step S5h).

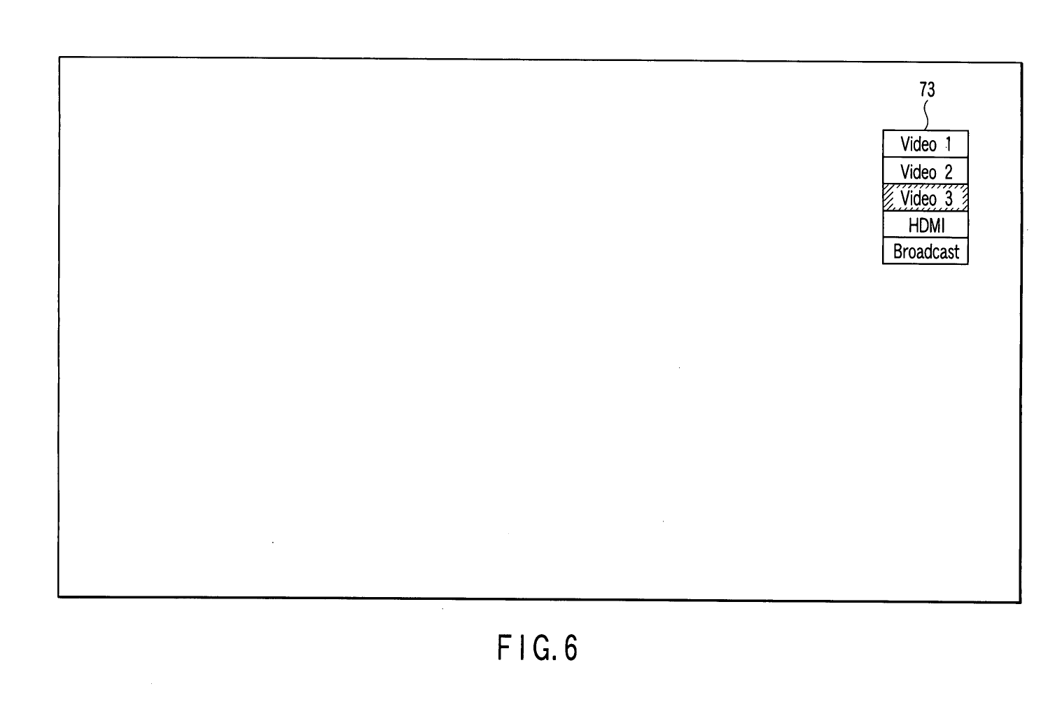

According to the embodiment described above, the input switch display area 73 is superimposed and displayed over the video display screen corresponding to the selected input. However, it may be arranged such that, as shown in FIG. 6, in the event of displaying the input switch display area 73, the video corresponding to any of, for example, signals and broadcast signals from the external input terminals 56a to 56d is set to a non-display state (blacked-out state, for example), and the audio is set to a muting state.

In addition, although the input switching is performed through the operation of the remote controller 17, it is not limited thereto. For example, the switching may be executed in the following manner. In the state where the input switch display area 73 is displayed in the OSD format on the video display 14, a desired one of the input items is selected through the operation of the cursor key 17f of the remote controller 17, and the input switching is executed through operation of the determination key 17g.

In addition, the input switching is executed such that, when the “broadcast” is selected, a finally selected channel, i.e., last channel, in all broadcasts is selected, irrespective of the satellite digital broadcasting or terrestrial wave. Further, in a no-signal state where no signals are received at the external inputs, the power supply is automatically set to a standby state.

The present invention is not limited to the embodiment described above, but may be embodied with components modified and altered in various ways in a practicing stage without departing from the spirit and scope of the invention. Further, the plurality of components disclosed in the embodiment may be appropriately combined, thereby to enable configuring various other forms of the invention. Further, for example, some of all the components disclosed and shown in the embodiment may be omitted. Furthermore, components according to different embodiments may be appropriately combined (without departing from the spirit and scope of the invention).

What is claimed is:

1. A signal reproduction apparatus comprising:
a plurality of input terminals;
a first operation handler configured to enable respective signals input to said plurality of input terminals to be cyclically selectable in a predetermined sequence;
a second operation handler configured to enable respective signals input to said plurality of input terminals to be cyclically selectable in a sequence opposite the predetermined sequence associated with the first operation handler; and
a signal processing means configured to perform a reproduction process on a signal selected by using at least one of the first and second operation handlers.

2. A signal reproduction apparatus according to claim 1, wherein
the first operation handler is one end portion of a key having two end portions supported to be selectively depressible substantially as seesaw movement with a central portion in the center, and
the second operation handler is the other end portion of the key.

3. A signal reproduction apparatus according to claim 1, further comprising an input switch display area display means configured to display an input switch display area provided to indicate a state of signal selection performed by using said at least one of the first and second operation handlers.

4. A signal reproduction apparatus according to claim 3, further comprising a control means configured to perform sequential switching of display of the input switch display area when one of the first and second operation handlers is intermittently operated at a time interval less than a preset predetermined time, and to allow selection of an input displayed in the input switch display area when operation of one of the first and second operation handlers is paused.

5. A signal reproduction apparatus according to claim 3, further comprising a video display means configured to perform video display in accordance with a signal on which the reproduction process has been performed by the signal processing means,
wherein the input switch display area display means causes the input switch display area to be superimposed and displayed on a video displayed in accordance with the signal on which the reproduction process has been performed by the signal processing means.

6. A signal reproduction apparatus according to claim 3, further comprising a video display means configured to perform video display in accordance with a signal on which the reproduction process has been performed by the signal processing means, and to cause a video not to be displayed when the input switch display area is displayed, the video being in accordance with the signal on which the reproduction process has been performed by the signal processing means.

7. A signal reproduction apparatus according to claim 3, wherein the input switch display area display means causes displaying the input switch display area list-displaying items corresponding to all selectable inputs.

8. A signal reproduction apparatus according to claim 7, further comprising a control means configured to select a predetermined item by using a cursor key from the items list-displayed in the input switch display area and to enable the item to be determined by using a determination key.

9. A signal reproduction method which selects a predetermined signal from respective signals input to a plurality of input terminals and which performs a reproduction process on the selected signal, the method comprising:
a first step of determining which of a first operation handler and a second operation handler has been operated;
a second step of, when it is determined that the first operation handler has been operated, performing cyclic selection of the respective signals input to said plurality of input terminals in a predetermined sequence;
a third step of, when it is determined that the second operation handler has been operated, performing cyclic selection of the respective signals input to said plurality of input terminals in a sequence opposite the predetermined sequence associated with the first operation handler; and
a fourth step of performing the reproduction process on a signal selected in the second or third step.

10. A signal reproduction method according to claim 9, further comprising a fifth step of displaying an input switch display area provided to indicate a state of signal selection performed in each of the second and third steps.

11. A signal reproduction method according to claim 10, wherein
the second step performs sequential switching of display of the input switch display area when the first operation handler is intermittently operated at a time interval less than a preset predetermined time, and selects an input displayed in the input switch display area when operation of the first operation handler is paused, and
the third step performs sequential switching of the display of the input switch display area when the second operation handler is intermittently operated at a time interval less than a preset predetermined time, and selects an input displayed in the input switch display area when operation of the second operation handler is paused.
